(19) United States
(12) Patent Application Publication
(10) Pub. No.: US 2007/0118334 A1
(43) Pub. Date: May 24, 2007

(54) Data logger for a measuring device

(76) Inventors: Klaus Guenter, Aichhalden (DE); Thomas Deck, Wolfach (DE); Josef Fehrenbach, Haslach (DE)

Correspondence Address: FAY KAPLUN & MARCIN, LLP, 15O BROADWAY, SUITE 702, NEW YORK, NY, 10038, US

(21) Appl. No.: 11/543,699

(22) Filed: Oct. 4, 2006

Related U.S. Application Data
(60) Provisional application No. 60/723,857, filed on Oct. 5, 2005.
(60) Provisional application No. 60/754,472, filed on Dec. 27, 2005.

(51) Int. Cl. G06F 17/40; G06F 13/36

(52) U.S. Cl. 702/187; 710/315

(57) ABSTRACT

A circuit arrangement for transmitting data between a field unit and a control device with a first data interface for being coupled to the control device and a second data interface for being coupled to the field unit. A galvanic isolator is situated between the data interface on the side of the control device and the data interface on the side of the field unit, wherein the first data interface and the second data interface are coupled in a communicating fashion by the galvanic isolator. The circuit arrangement furthermore features at least one data storage device, wherein the data storage device is either coupled to the first data interface or the second data interface. The data storage device is designed in such a way that data of at least the first or the second data interface can be recorded on demand by the data storage device.

### CLAIM OF PRIORITY

This application claims the benefit of the filing date of U.S. Provisional Patent Application Ser. No. 60/754,472 filed Dec. 27, 2005, and U.S. Provisional Patent Application Ser. No. 60/723,857 filed Oct. 5, 2005, the disclosures of both applications are hereby incorporated herein by reference.

### FIELD OF THE INVENTION

The present invention relates to the general technical field of measuring devices. The present invention specifically relates to a circuit arrangement for transmitting data between a field unit and a control device, a data logger, a field unit arrangement, a method for transmitting data, a circuit arrangement for storing data of a field unit and for transferring the data to a control device and the utilization of a portable data storage device for storing data of a field unit and for transferring the data to a control device.

### BACKGROUND INFORMATION

For measuring the level of liquids and solids in receptacles by measuring the transit time of electromagnetic waves, measuring devices are usually installed on or in the receptacle wall. The measuring device subsequently transmits waves in the direction of the fill either in a guided fashion by a waveguide or in a radiant fashion by an antenna. The waves reflected on the fill are subsequently received again by the measuring device. The distance between the sensor and the fill can be deduced from the thusly determined transit time, and the filling height can be deduced from information on the position of the sensor relative to the bottom of the receptacle.

### SUMMARY OF THE INVENTION

There may be a need to provide a reliable data transmission device for measuring signals.

Accordingly, a circuit arrangement or circuit system for transmitting data between a field unit and a control device, a data logger, a field unit arrangement, a method for transmitting data, a circuit arrangement for storing data of a field unit and for transferring the data to a control device and the utilization of a portable data storage device for storing data of a field unit and for transferring the data to a control device according to the independent claims are created.

According to one exemplary embodiment of the present invention, a circuit arrangement for transmitting data between a field unit and a control device is disclosed. In this case, the circuit arrangement comprises a first data interface that serves for coupling the circuit arrangement to the control device. A second data interface makes it possible to couple the circuit arrangement to the field unit. The circuit arrangement furthermore comprises at least one data storage device.

The first data interface and the second data interface are coupled in a communicating fashion. The data storage device is coupled to at least the first data interface or the second data interface. The data storage device is designed for storing or intermediately storing or buffering data exchanged between the first data interface and the second data interface on demand.

It may be of interest that measuring data accumulated during a measuring time is not immediately forwarded to a control device or an evaluation device. Possible instances in which an immediate forwarding of measuring values may not desirable could occur, for example, if it is required to evaluate a time series. The measuring values should be made available cumulatively in this case.

An interface device featuring a data storage device may acquire measuring values over a period of time without being connected to the control device. Consequently, series of measurements may be recorded over a period of time in an autarkic fashion. In this context, the term autarkic means, in particular, that it is not necessary to connect a control device to the measuring device simultaneously with or during the measurement and that this control device does not have to be monitored. Series of measurements therefore may be recorded over night. In other words, the circuit arrangement is may not be dependent on being supplied with energy by the control device.

Another example for the delayed forwarding of measuring values might be the recording of so-called envelopes. If the measuring device is, for example, an ultrasonic or radar measuring device in which an echo is reflected by a fill, the interesting aspect is frequently not the exact time history of the echo values, but rather the tendency that may be illustrated in the form of an envelope, particularly an echo envelope. An envelope may trace, for example, extreme values of a temporal oscillation. The positions of objects may be determined, for example, from the echo envelopes of radar sensors.

The data storage may also be useful when a data jam occurs. If excessive data for an interface is momentarily present for additional processing, a data storage device may make it possible to intermediately store, log, protocol or buffer data. Summarily stated, the data storage device may make it possible to improve the data integrity, particularly the recording and evaluating of existing data.

According to another exemplary embodiment of the present invention, a data logger with a circuit arrangement for transmitting data between a field unit and a control device is provided. A data logger may be used in the form of an autarkic device for coupling a control device and a field unit in an explosive area and for buffering data. The data logger may be operated in an autarkic fashion because it either features its own internal power supply or may be supplied with energy by a field unit. If the data logger is operated with energy supplied by the field unit, the measuring system comprising the field unit and the data logger is operable in an autarkic fashion as a unit.

According to yet another exemplary embodiment of the present invention, a field unit arrangement with a circuit arrangement or a data logger and a field unit is provided. The circuit arrangement and the data logger have the above-described features.

According to yet another exemplary embodiment of the invention, a data transmission method is provided, particularly a method for the serial transmission of data, wherein data is transmitted between the first data interface and the second data interface and the data to be transmitted is stored on demand.

According to another exemplary embodiment of the present invention, a circuit arrangement for storing data of a field unit and for transferring the data to a control device is provided. The circuit arrangement comprises a data interface that is designed for being couplable to a field unit as well as to a control device. The data interface comprises a data storage device that is designed for recording data of the data interface on demand and once again making available the data at the data interface on demand.

In this case, the data storage device may be designed for recognizing that the circuit arrangement was coupled to a field unit, particularly to an interface of the field unit. The coupling may cause the data storage to automatically collect existing data of the field unit and to store this data in the data storage device.

The circuit arrangement may be realized in a portable fashion such that it is easily couplable to the field unit.

The circuit arrangement may be realized such that it is connectable to an control unit by the same data interface with which it is couplable to the field unit. When the connection with the control device is produced, the data storage may recognize that data is present in the data storage device and that the control device is designed for receiving the data. This may cause the data storage to transmit the data to the control device. A portable storage device for the field unit may be created in this fashion.

A wire-bound bus system for transmitting data to a control device can be omitted on the field unit. The data transmission as well as the transmission of parameters or control commands for the field unit can be realized by the portable storage device.

According to another exemplary embodiment of the present invention, a utilization of a portable data storage device for storing data of a field unit and for transferring the data to a control device is provided. A data transmission between a field unit and a control device may be realized, for example, with a memory stick.

According to another exemplary embodiment of the present invention, the circuit arrangement comprises a galvanic isolator. The galvanic isolator is coupled in a communicating fashion between the first data interface and the second data interface.

The data storage device may be arranged upstream or downstream of the galvanic isolation referred to a data flow direction. For example, due to its buffer effect a data storage device upstream of a galvanic isolation may be able to equalize the bottleneck of the galvanic isolation.

When working in a so-called ex-environment, it may be required that electrical devices need to fulfil certain prerequisites in order to operate these devices in the ex-environment. An ex-environment may be divided into several classes of protection. Ex-areas may be areas in which potentially explosive materials or process factors are utilized. If a measuring device used in an ex-area produces a spark discharge, this spark discharge may lead to the accidental ignition of the material due to the vicinity of the measuring device to the potentially explosive material such that an explosion is triggered.

An example for the utilisation of a measuring device in a potentially explosive area, is the use of a level gauge unit for measuring levels in an oil tank. Due to the size of the oil tank, it may occur that the housing of the oil tank has a potential that differs from the potential of a control device. A control device may be required for operating the measuring device or a field unit.

Since a bus system may be an electrically conductive system, the connection of a control device and a measuring device to an oil tank may make it possible for an electric charge balancing to take place between the oil tank and therefore also the measuring device and the control device. An equalization of the potential difference can be prevented by a galvanic isolation of the electrically conductive system. In other words, the galvanic isolation of the measuring device and of the control device may make it possible to prevent a low-frequency current, particularly a direct current, from flowing between the measuring device and the control device.

According to another exemplary embodiment of the present invention, the circuit arrangement may feature at least a first and at least a second parallel/serial converter. The first parallel/serial converter is coupled to the first data interface and the second parallel/serial converter is coupled to the second data interface. The first and the second parallel/serial converter are designed for transmitting data between one another in a serial fashion.

Parallel/serial converters may make it possible to transmit a signal with a certain bit size that is present in the form of a parallel digital signal over a single serial line. This in turn may make it possible, for example, to reduce the number of required connections between two data interfaces. For example, the mutual impact of the duplex effect of parallel lines can be prevented in this fashion.

Due to the reduction of the required connections between the interfaces, the number of connecting lines, for example, between two coupled modules may also be reduced. Consequently, the number of possibly required galvanic isolators may be reduced because each electrical connection between interfaces, in which different potentials can occur, may be separated by a galvanic isolator in order to prevent compensating currents. The number of required galvanic elements therefore may be reduced by serializing parallel data.

The first parallel/serial converter and the second parallel/serial converter may also be coupled in a communicating fashion such that the first parallel/serial converter is arranged between the first data interface and a galvanic element and the second parallel/serial converter is arranged between the second data interface and the galvanic element. In this case, a serial data transmission takes place between the first parallel-serial converter and the second parallel-serial converter.

According to another exemplary embodiment, the first parallel/serial converter or the second parallel/serial converter or the first parallel/serial converter and the second parallel/serial converter are realized in the form of LVDS components. The LVDS (Low Voltage Differential Signalling) technology may make it possible to transmit parallel data in a serial fashion. LVDS is an interface standard for data transmission. In this case, a low voltage is used, i.e., a lower voltage is used instead of the conventional high voltage of 5 V (TTL) or 3 V for digital systems.

Consequently, a relatively high voltage differential, for example, of 3 V is not required for distinguishing between a zero and a one and a correspondingly high power consumption may be prevented. The LVDS technology typically operates with 0.4 V and a line impedance of 100 Ohm. The charge of the cable to be changed with each signal edge therefore may be lower and faster signal edges may be realized.

LVDS is based on a differential signal transmission, i.e., a tightly arranged two-wire system, the signals of which are phase-shifted by 180°. This may make it possible to easily and efficiently filter interferences because an interference occurs at the same location in both lines and with the same intensity. At a line length of 2 m, the typical data rate attainable with the LVDS technology is 200 megabit per second. Other ranges of data rates attainable by the LVDS technology lie between 520 megabit per second and 600 megabit per second or between 600 megabit per second and 1.5 gigabit per second.

According to another exemplary embodiment of the present invention, the circuit arrangement comprises a first interface driver. The first interface driver may be designed for realizing an adaptation of the low LVDS logic level to a voltage, energy or power level of the interface. For example, the first data interface may be realized in the form of a USB (Universal Serial Bus) interface for a control device, the level of which lies at approximately +5 V. A first interface driver would carry out the corresponding voltage adaptation.

An interface driver may be able to adapt the existing useful or wanted signals to the levels required by the respective interface standard and to a time response of the signals that corresponds to the standard.

According to yet another exemplary embodiment of the present invention, the circuit arrangement comprises a second interface driver at its second data interface. The second interface driver may be designed, for example, for making available a power level for a field unit specific interface at the second data interface. If the field unit to be connected to the circuit arrangement is a field unit with a HART® bus, the voltage levels lie on the order of 270 mV to 700 mV as typically required by HART® bus.

Different voltage levels for the control device and the measuring device may be realized with different interface drivers at the control device interface and at the measuring device interface.

The data logger may be designed, in particular, in the form of an interface converter, i.e., in the form of a device that may make it possible to use a different interface format between the interface for connecting the control device and the interface for connecting the field unit. Due to these measures, two devices that are based on completely different standards may also communicate with one another if a data logger according to an exemplary embodiment is connected in series as a “translator.” It is possible to achieve a modular design, in which the interface drivers are realized in an exchangeable or detachable fashion.

According to another exemplary embodiment of the present invention, the first data interface may consist of a USB interface, a RS.232 interface or another conventional interface of a data processing device. The control device usually may be a PC or a PDA. Due to the providing of a corresponding interface an operation of the circuit arrangement with the control device may be made available.

According to yet another exemplary embodiment of the present invention, the second data interface may be a HART® bus interface, a VBUS interface, a field bus interface or an I²C bus interface. The second data interface can be adapted to an interface of a measuring device. Consequently, a measuring device may be connected to the second data interface such that data made available by a measuring device may be received.

According to yet another exemplary embodiment of the present invention, the circuit arrangement comprises another galvanic isolator. In this case, the additional galvanic isolator is designed for galvanically isolating an energy supply for the circuit arrangement.

The energy supply can supply two separate circuit components with energy without risking that a direct current flows between the circuit components via the energy supply.

According to another exemplary embodiment of the present invention, the data storage device is realized in the form of a Flash NAND. A Flash NAND may be a storage component that may allow a high data throughput. Data can therefore be written and read very quickly. The high access speed may make it possible to increase the processing speed of the circuit arrangement as a whole. This increase in the processing speed may make it possible to improve the overall performance of the circuit arrangement. The data storage device can be adapted to the high transmission rate of the serial data connection by a NAND Flash Memory. In other words, the processing speed of the data storage device is adapted to the transmission rate of the serial connection.

According to yet another exemplary embodiment of the present invention, the galvanic isolator comprises at least one capacitor. A capacitor may be formed by two circuit boards that are separated by a dielectric material. Such an isolation by dielectric material may make it possible to prevent a spark discharge and the flow of a direct current between the capacitor boards. The circuit arrangement may be able to fulfil the ex-protection or explosive protection requirements with the aid of a galvanic isolator in the form of a capacitor. From a physical point of view, two circuits that are non-conductively connected to one another are created by the dielectric material.

It is also possible to utilize capacitor banks and capacitors that are interlinked in a parallel and/or serial fashion.

A capacitor in a line may prevent a charge exchange between the elements connected to the line. Consequently, a capacitor between the first data interface and the second data interface may prevent a current from flowing between the two interfaces. LVDS connections may be realized differentially. Each connection may therefore comprises a plurality of lines. Each of these lines may comprise a galvanic isolator in the form of a capacitor.

Numerous additional developments of the invention were described with reference to the circuit arrangement, the data logger and the field unit arrangement. These embodiments also apply to the method for the serial transmission of data.

I2C or I²C (for Inter-Integrated Circuit) is a serial bus for computer systems. It can be used for connecting devices with a slow transmission rate to an embedded system or a motherboard.

The HART® Protocol (Highway Addressable Remote Transmitter) can be designated, in particular, as an open master-slave protocol for bus-addressable field units. It can be used for implementing a method, in which data is transmitted on the 4 to 20 mA process signal by Frequency Shift Keying (FSK) in order to realize remote configurations and diagnostic checks.

I²C as well as HART® are suitable protocols for the communication with a field unit, e.g., with a fluidimeter or with a pressure measuring device or manometer.

### BRIEF DESCRIPTION OF THE DRAWINGS

Exemplary embodiments of the present invention are described below with reference to the figures.

FIG. 1 shows a block diagram of a circuit arrangement for transmitting data between a field unit and a control device according to an exemplary embodiment of the invention.

FIG. 2 shows a field unit arrangement according to an exemplary embodiment of the invention.

FIG. 3 shows a field unit arrangement according to an exemplary embodiment of the invention.

FIG. 4 shows a field unit arrangement according to an exemplary embodiment of the invention.

FIG. 5 shows a circuit diagram of a data logger according to an exemplary embodiment of the invention.

### DETAILED DESCRIPTION

Identical or similar components are identified by the same reference signs in different figures.

The figures show schematic representations that are not drawn true-to-scale.

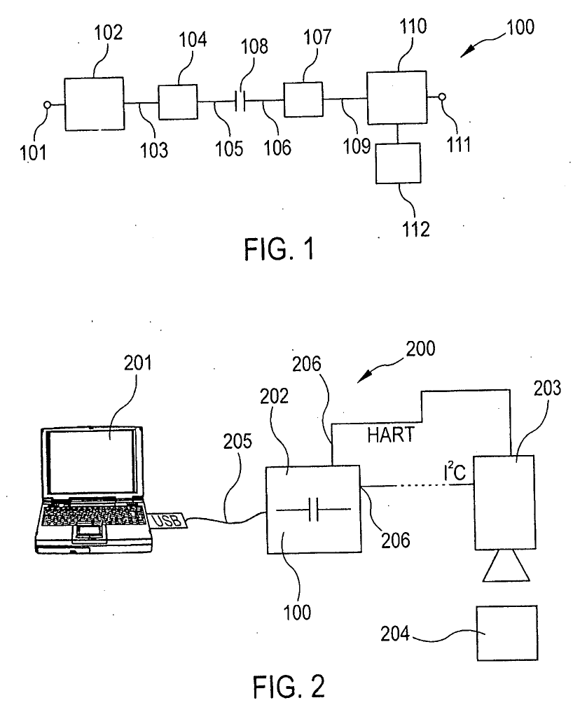

FIG. 1 shows a block diagram of a circuit arrangement 100 for transmitting data between a field unit and a control device (neither of which is illustrated in FIG. 1). A control device can be connected to the first interface 101. The signal level required for the operation, particularly the energy required for the operation, is drawn from the interface or the control device connected thereto by the first interface driver 102. The first interface driver 101 may be realized, for example, in the form of a USB connection and draw energy via a line provided for this purpose in the USB connection.

Alternatively and additionally to the energy supply, the interface driver 102 is also responsible for forwarding received data. The first interface driver 102 receives and/or transmits data via the parallel lines 103. In the present instance, the parallel incoming line 103 has a size or width of eight bit. This data transmission takes place separately in the outgoing direction and in the incoming direction. A data line with a size of eight bit is used for each direction.

The first parallel/serial converter 104 is responsible for converting parallel data that is received and/or transmitted via the line 103 into serial data that is transmitted and/or received via the line 105. The first parallel/serial converter 104 generates the so-called LVDS signals on the line 105. In order to be forwarded to the adjacent parallel/serial converter 107, the signal needs to bypass the galvanic isolator 108 and reach the second parallel/serial converter 107 via the serial LVDS line 106. The galvanic isolation 108 forms a nearly infinite resistance for a DC-signal or a common-mode signal such that this common-mode signal cannot propagate via the galvanic isolation 106. The propagation via the galvanic isolator 108 can take place in the direction from the first parallel/serial converter 104 to the second parallel/serial converter 107 as well as in the reverse direction.

The second parallel/serial converter 107 can convert a signal that was received serially via the line 106 back into parallel data streams. The parallel data streams are made available to the second interface driver 110 on the line 109. In this case, the second interface driver 110 can physically adapt the parallel data to the corresponding measuring interface 111. This adaptation is carried out, in particular, with respect to signal levels and timing response or timing behaviour. A measuring interface 111 in the form of an I²C interface differs from a HART® bus protocol such that only adapted interfaces 111 can be used for communicating with the corresponding device. The type of the interface 111 can be adjusted with a change-over switch. In this case, the interface to be used can be selected by the circuit arrangement.

Alternatively or additionally to the energy supply via the first interface 101 and the first interface driver 102, an energy supply for the circuit 100 can be realized via the second interface 111 and the second interface driver 110. Consequently, it is possible to utilize a field unit connected to the second interface 111 for supplying the circuit with energy.

A change-over for determining whether the circuit arrangement 100 should be supplied with energy via the first interface 101 or via the second interface 111 can be realized automatically, for example, in that the circuit 100 recognizes to which interface an energy supply is actually connected.

In FIG. 1, the data memory 112 is also connected to the second interface driver 110. For data which are transmitted from the measuring device at the connection or terminal 111 to the control device at the connection or terminal 101 the data memory lies upstream of the galvanic isolator 108. This data memory may be an integrated or an external data memory 112. An external data memory 112 is illustrated in FIG. 1. The data memory 112 can be used for intermediately storing or buffering data that is transmitted via the second interface 111 faster than it can be processed further by the parallel/serial converter 107.

The circuit arrangement 100 can be used for the data exchange between a measuring device and a control device.

FIG. 2 shows a field unit arrangement according to an exemplary embodiment of the present invention. The field unit arrangement 200 contains a control PC 201, a data logger 202 and a level gauge 203 for measuring the level in a connected tank 204.

The data logger 202 features a circuit arrangement 100 for transmitting data. The data logger 202 contains a first data interface 205 that is realized in the form of a USB connection 205 such that the PC 201 and the data logger 202 are coupled via the USB bus 205.

The interface converter 202 furthermore contains second data interfaces 206 by which the data logger 202 may be coupled to the level gauge 203, namely in a selective fashion in accordance with the I²C standard or the HART® standard. In the configuration shown in FIG. 2, the data logger 202 and the level gauge 203 are coupled in accordance with the HART® standard.

The data logger 202 can be supplied with energy via the USB connection 205 as well as via the measuring connection 206. The energy source can be selected by the data logger in this case. A change-over can take place automatically.

The data logger 202 furthermore realizes a galvanic isolation between the control PC 201 and the level gauge 203 which level gauge may be arranged in a potentially explosive environment. The circuits 206 and 205 are physically decoupled due to the galvanic isolation.

The data logger 202 is able to record or log data exchanged between the PC 201 and the level gauge 203 in an internal memory of the data logger 202 (not illustrated in FIG. 2). The data logger 202 therefore serves for recording data of a field unit or sensor 203, for example, measuring values with time stamps or echo envelopes.

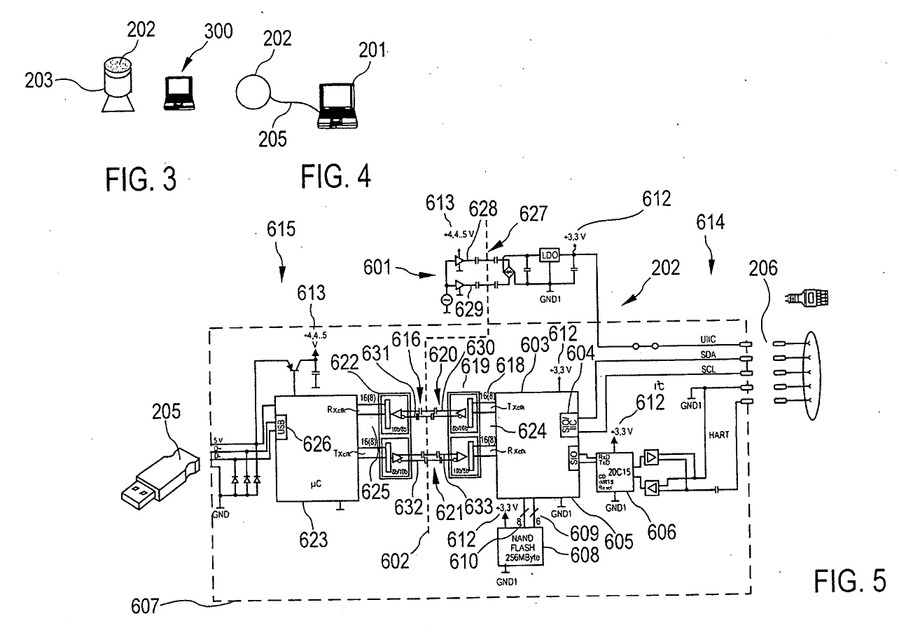

FIG. 3 once again shows a field unit arrangement that can be coupled to a programming device 300 for adjusting the data recording. Furthermore, the data logger 202 of FIG. 2 is also illustrated in this figure, namely in the state in which it is attached to the level gauge 203. The data logger 202 has a shape and a connecting device that are adapted for the connection to the field unit 203. The programming device 300 and the data logger 202 are not coupled in FIG. 3.

The data logger 202 is able to store data that it receives from the measuring device 203 in an autarkic fashion, i.e., without having to be connected to the USB connection 205 of the control device 300. The stored data can be read out of the data logger 202 at a later point in time by the PC 201. This can be achieved without having to connect the data logger 202 to the field unit. During the recording process, the data logger may draw energy from its own energy supply, for example, a power pack or a solar cell (not illustrated in FIG. 3) or via the field unit.

FIG. 4 shows another field unit arrangement, in which a control PC 201 is coupled to the data logger 202 by a USB bus 205. A readout of data can be performed in this fashion. Data collected in an autarkic mode of the data logger 202 can also be processed further. The data logger 202 is not connected to a field unit in FIG. 4. Consequently, the data is stored in the data logger 202 and can be read out without an additional connection to the field unit.

FIG. 5 shows a plurality of components, wherein the following portion of the description primarily refers to the circuit arrangement 607. The circuit arrangement or circuit structure 607 shows an arrangement for transmitting data between a field unit and a control device. In the circuit arrangement 607 shown, the data is transmitted bidirectionally between the USB connection 205 and the measuring device connection 206. The measuring device connection 206 can be selectively changed over between an I²C bus connection 206 and a HART® connection 206. In other words, the connection 206 always has the same physical pins. The content of the signals on the individual lines or pins of the connection 206 can be distinguished in accordance with the different bus standards.

The signals for the I²C bus are made available via the output 604 of the microcontroller 603. Furthermore, the signals of the HART® bus are made available at the connection 206 via the output 605 of the microcontroller 603 and the HART® interface driver 606. The measuring device connection 206 makes it possible to transmit signals to a measuring device, i.e., out of the circuit arrangement 607, as well as from the measuring device, i.e., into the circuit arrangement 607.

The microcontroller 603 is connected to a data memory 608 which, in this case, is a Flash NAND with a capacity of 256 MB. The data memory 608 is connected by a six-conductor line 609 and an eight-conductor line 610. The flash memory 608 is connected to the energy supply 601 via the energy supply line 612. The energy supply 601 has the potential 612 on the side of the measuring device and the potential 613 on the side of the control device, wherein the potential 613 on the side of the control device exceeds the potential 612 on the side of the field unit. The potential on the side of the control device may lie, for example, in the range between +4.4 V and +5 V, and the potential on the side of the field unit may lie in the range between +3 V and +3.3 V.

A separation between the two potentials 612 and 613 is indicated with the virtual dividing line 602. The galvanic isolation of the potentials 612 and 613 is realized by the galvanic isolator 627 in the energy supply 601. The galvanic isolator 627 comprises four capacitors, wherein two respective capacitors are arranged in each of the supply lines 628 and 629.

The dividing line 602 symbolizes the galvanic separation between the section 614 of the circuit arrangement 607 on the side of the measuring device and the section 615 of the circuit arrangement 607 on the side of the control device. The galvanic isolator 616 serves for realizing the galvanic isolation between the section 614 of the circuit arrangement 607 on the side of the field unit and the section 615 of the circuit arrangement 607 on the side of the control device with respect to the signalling lines 620 and 621.

Consequently, a complete galvanic isolation between the control device side 615 of the circuit arrangement 607 and the measuring device side 614 of the circuit arrangement 607 is realized by the galvanic isolators 627 and 616. The energy supply as well as the data connection between the control device side 615 and the field unit side 614 are therefore isolated. The energy can be drawn, for example, via the USB interface 205 in this case.

In FIG. 6, the galvanic isolator 616 is illustrated in the form of four capacitors that prevent a compensating current from flowing between the two circuits sections 614, 615 due to the different potentials 612, 613. This compensating current could not only be caused by the different potentials 613 and 612, but also by an electrical charge build up on the field unit side. An alternating current, in contrast, is able to overcome the galvanic isolation 616 and signals can be transmitted via the galvanic isolator 616 because the information in signals is usually of alternating nature.

A possible compensating current could cause a spark discharge that could lead to an explosion if the circuit arrangement 607 is used in an ex-area. In order to maintain the number of galvanic isolators 616 between the two circuit sections as small as possible, the data made available at the output 618 of the IC of the microcontroller 603 in the form of parallel signals is converted into a serial data stream, i.e., a successive data stream, by using serial/parallel converters 619. A conversion of a parallel signal with a width of 16 bit takes place onto a serial outgoing line 620. In the opposite direction, the transmission on the serial line 621 takes place analogous to the above-described conversion method. The direction of the data transmission can be defined by a change-over switch (not illustrated in FIG. 6). A microcontroller can be used for changing over the direction.

The serial data stream on the line 620 reaches the serial/parallel converter 622, in which the serial signal is converted back into the data signal of 16 bit width that is made available to the microcontroller and/or the driver stage 623. The clock signal is transmitted via the lines 624 and/or 625 parallel to the data transmission taking place on the lines 618. The transmission in the opposite direction is realized similarly.

The serial lines 620 and 621 indicated in the form of parallel lines are designed for the transmission of differential signals. The signal transmission on the two lines 620 and 621 takes place in opposite directions. For this purpose, the lines 620 and 621 respectively comprise tightly adjacent parallel sections 630, 631 and 632, 633, on which differential signals are transmitted. Each of the sections 630, 631 and 632, 633 comprises two capacitors for physical separation purposes.

The levels of the signals on the lines 630 and 631 are mutually inverted. Analogously, the levels on the lines 632 and 633 are mutually inverted. A clock signal can be used for synchronizing the signals transmitted via the lines.

The driver 623 makes available the received parallel data at the output 626 in the form that corresponds to the USB standard. The signals at the output 626 of the driver stage 623 are made available to the interface 205 together with the control device voltage 613.

A galvanic isolation is also realized in the energy supply 601. This means that a complete galvanic isolation of the data logger 202 is realized. That is, the energy supply as well as the data connection are separated between the control device side 615 and the field unit side 614. The energy can be drawn, for example, via the USB interface 205.

It should be noted that “comprising” does not exclude any other elements or steps, and that “a” or “one” does not exclude a plurality. It should furthermore be noted that characteristics or steps that were described with reference to one of the above embodiments can also be used in combination with other characteristics or steps of other above-described embodiments. Reference signs in the claims should not be understood in a restrictive sense.

1. A circuit arrangement for transmitting data between a field unit and a control device, comprising:
a first data interface couplable to the control device;
a second data interface couplable to the field unit; and
at least one data storage device;
wherein the first data interface and the second data interface are coupled in a communicating fashion;
wherein at least one data interface of the group consisting of the first data interface and the second data interface is connected to the at least one data storage device; and
wherein the at least one data storage device is designed for recording data of at least one data interface of the group consisting of the first data interface and the second data interface if required.

2. The circuit arrangement of claim 1, further comprising
a galvanic isolator;
wherein the first data interface and the second data interface are coupled in a communicating fashion via the galvanic isolator.

3. The circuit arrangement of claim 1, further comprising:
at least a first parallel/serial converter; and
at least a second parallel/serial converter;
wherein the at least one first parallel/serial converter is coupled to the first data interface;
wherein the at least one second parallel/serial converter is coupled to the second data interface; and
wherein the at least one first parallel/serial converter and the at least one second parallel/serial converter are designed for transmitting data between one another in a serial fashion.

4. The circuit arrangement of claim 3, wherein the first parallel/serial converter and/or the second parallel/serial converter is realized in the form of a LVDS component.

5. The circuit arrangement of claim 1,
wherein the first data interface comprises a first interface driver.

6. The circuit arrangement of claim 1,
wherein the second data interface comprises a second interface driver.

7. The circuit arrangement of claim 1,
wherein the first data interface is a USB interface or an RS.232 interface.

8. The circuit arrangement of claim 1,
wherein the second data interface is at least one interface that is selected from the group consisting of HART® bus interface, VBUS interface, field bus interface or I²C bus interface.

9. The circuit arrangement of claim 1,
wherein the at least one data storage device is a Flash NAND memory.

10. The circuit arrangement of claim, further comprising:
a further galvanic isolator;
wherein the further galvanic isolator is designed for galvanically isolating an energy supply of the circuit arrangement.

11. The circuit arrangement of claim 2,
wherein the galvanic isolator comprises at least one capacitor.

12. A data logger with a circuit arrangement of claim 1 for transmitting data between a control device and a field unit.

13. A field unit arrangement, comprising:
a field unit and
a circuit arrangement of claim, or
a field unit, and
a data logger of claim 12.

14. The field unit arrangement of claim 13, wherein the field unit is selected from the group consisting of a level gauge, a pressure gauge and a radar measuring device.

15. A method for transmitting data, comprising:
transmitting data between a first data interface and a second data interface; and
on demand storing of the data to be transmitted between the first data interface and the second data interface in a data memory.

16. The method of claim 15, further comprising:
galvanic insolating of the first data interface and the second data interface by using a galvanic isolator;
converting of a parallel signal into a serial signal; and
serially transmitting of the serial signal between the first and the second data interface via the galvanic isolator.

17. A circuit arrangement for storing data of a field unit and for transferring the data to a control device, wherein the circuit arrangement comprises:
a data interface; and
at least one data storage device;
wherein the data interface is designed for being coupled to the field unit; and
wherein the data interface is designed for being coupled to the control device;
wherein the data interface is connected to the at least one data storage device;
wherein the at least one data storage device is designed for recording data of the data interface on demand, wherein the data is provided in a field unit bus protocol format; and
wherein the at least one data storage device is designed for making available data, which is in a field unit bus protocol format, at the data interface on demand.

18. The utilization of a portable data storage device for storing data of a field unit and for transferring the data to a control device.
